(19) United States
(12) Patent Application Publication
(10) Pub. No.: US 2008/0088275 A1
(43) Pub. Date: Apr. 17, 2008

(54) Battery-cleaning device

(76) Inventor: Tzu-Chih Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/546,291

(22) Filed: Oct. 12, 2006

(51) Int. Cl. H02J 7/00

(52) U.S. Cl. 320/112

(57) ABSTRACT

A battery-cleaning device is disposed on a casing of an electronic device. The casing has a battery slot which can receive at least one battery within. The battery-cleaning device comprises a rod, a spacer and a plate sheet. The rod is disposed on the casing movably. The spacer is fixed on the rod, and can be moved with the rod. The spacer extends to the battery slot, and is adjacent against to the surface of the battery. The plate sheet has at least one scrape part, and is disposed at the end of the battery. The device rotates the battery by the spacer, and scrapes the dirty things on the end of the battery. The device can clean the battery and prevent it raising the impedance.

### BACKGROUND OF THE INVENTION

1. Field of the Invention

The present invention relates to a battery-cleaning device, and particularly relates to a battery-cleaning device that cleans the dirt on the surface of positive pole and negative pole of the battery.

2. Description of the Related Art

Electronic devices like cameras, video cameras or mobile phones etc . . . are all powered from battery. There is always a battery slot on the casing of the electronic devices for receiving batteries. When the power of the batteries is not enough, batteries can be changed by taking them out from the battery slot or charge the batteries.

However, in the process of withdrawing the batteries to change and charging batteries, the surface of the positive and negative pole of the battery might be stained with oil or moisture and produce dirt when they are in contact with the user or charging device, leading to rising impedance of the battery. The electronic devices would often have a low battery phenomenon after a short while of usage. Thus, the characteristics of the battery would get worse and cannot be used continuously.

### SUMMARY OF THE INVENTION

One particular aspect of the present invention is to provide a battery-cleaning device. The battery-cleaning device is able to scrape the dirt off from the surface of the positive and negative pole of the battery by rotating the battery. Thus, avoids rising impedance of the battery and to supply power to electronic devices normally and continuously.

In order to achieve above-mentioned aspects, the present invention provides a battery-cleaning device, disposed on a casing of an electronic device. The casing has a battery slot which can receive at least one battery within. The device for cleaning battery comprises a rod, disposed on the casing movably; a spacer fixed on the rod and can be moved with the rod, the spacer extends to the battery slot, and is adjacent against to the battery surface; and a plate, disposed at one end of the battery and is located inside the casing and has at least one scrape part. The scrape part is adjacent against to the surface of one end of the battery.

The present invention comprises the following effective advantages. The present invention of battery-cleaning device uses the spacer to rotate the battery. Furthermore, employs the plate sheet to scrape off the dirt produced on the positive and negative pole of the battery. Thus, lowers the impedance battery and keeps the positive and negative pole of the battery clean. As a result, the battery is able to supply continuous power for the normal usage of electronic devices.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, assembled figure of a battery-cleaning device according to the present invention;

FIG. 2 is a perspective, exposed figure of a battery-cleaning device according to the present invention; and

FIG. 3 is a schematic diagram for a battery and a plate sheet of a battery-cleaning device according to the present invention.

### DETAILED DESCRIPTION OF THE PREFERRED EMBODIMENTS

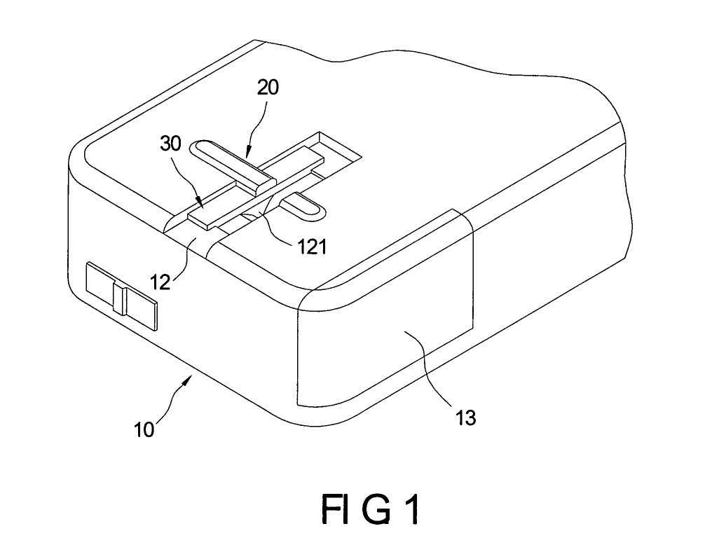

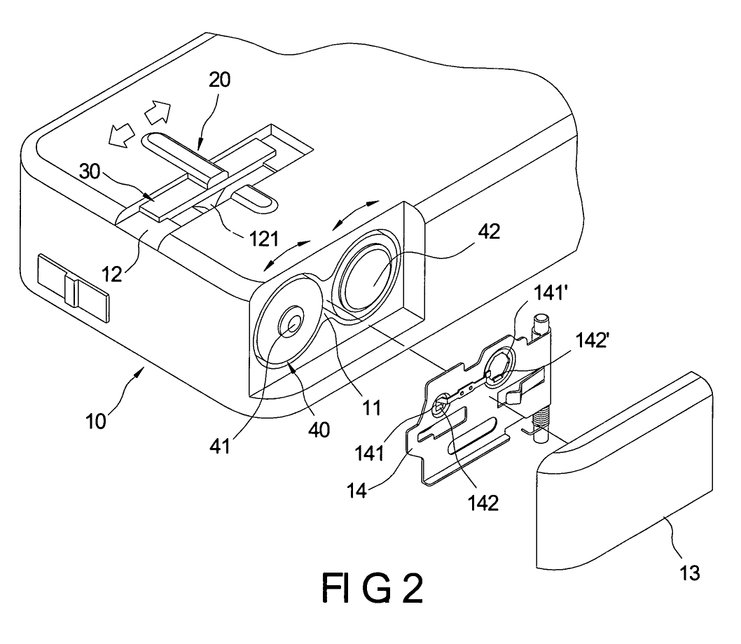

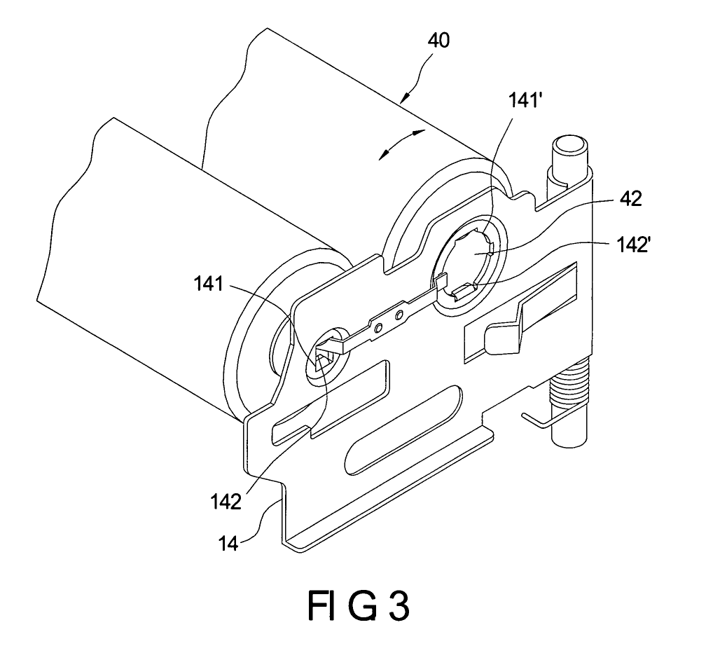

Please refer to FIG. 1 to FIG. 3. The present invention of the battery-cleaning device is disposed on the casing 10 of an electronic device. The casing 10 can be casing for cameras, casing for video cameras, casing for mobile phones and other electronic devices' casing. The battery-cleaning device comprises a rod 20 and a spacer 30.

Firstly, the figures of this invention are based on a camera casing. The casing 10 is made from plastic and is formed in a square shape. There is a battery slot 11, inside the casing 10, for receiving two batteries 40. The two batteries 40 are placed oppositely inside the battery slot 11 and the two batteries' 40 positive surface 41 and negative surface 42 are exposed in the opening end of the battery slot 11. On the casing 10, there is a battery cover 13 corresponded to one end of the two batteries 40 in battery slot 11. The battery cover 13 is joint to the casing 10 and can open or close on the casing 10.

There is a rectangular, concave placing slot 12 on the surface of the casing 10. An opening hole 121 is set in the center of the placing slot 12. The opening hole 121 penetrates the surface of the casing 10 and is interlinked with the battery slot 11.

There is a plate sheet 14 further established between the casing 10 and the battery cover 13. The plate sheet 14 is made from metal. The plate sheet 14 is placed between one side of the two batteries 40 and fixed in the interior of the battery cover 13.

The plate sheet 14 comprises a first penetrating slot 141 and a second penetrating slot 141′. The first 141 and second 141′ penetrating slot penetrates the plate sheet 14 and is corresponded to the surface of the positive 41 and negative 42 pole of the battery 40 forming a spaced interval setting.

The first penetrating slot 141 is formed slightly like a square shape. In the interior of the first penetrating slot 141, there are two first scrape part 142. The two first scrape part 142 is disposed face to face. Every first scrape part 142 is formed by bending and expending the plate sheet 14 to the surface of the positive pole 41 of the battery 40. The two first scrape parts 142 is adjacent against to the surface of the positive pole 41 of the battery 40.

The second penetrating slot 141′ is formed slightly like a round shape. In the interior of the second penetrating slot 141′, there are also two second scrape part 142′ disposed face to face. Every second scrape part 142′ is formed by bending and expending the plate sheet 14 to the surface of the negative pole 42 of the battery 40. The two second scrape parts 142′ is adjacent against to the surface of the negative pole 42 of the battery 40.

The rod 20 is form in a bar shape and is disposed perpendicular to the placing slot 12 on the casing 10. The rod 20 extends into the placing slot 12 and connects with the spacer 30. The rod 20 is movable and is set on the surface of the casing 10. User is able to push the rod 20 to move according to the casing 10.

The spacer 30 is made from high friction soft material, e.g. rubber. The spacer is formed in a square shape and is disposed in the placing slot 12 of the casing 10. The top end of the spacer 30 is fixed on the rod 20. The bottom end of the spacer 30 passes through the opening hole 121 and stretches into the inside of the battery slot 11 and is adjacent against to the outer rim of the two batteries 40. The spacer 30 moves with the rod 20. Since the material of the spacer 30 is softer, the spacer 30 is able to change its shape according to the shape of the outer rim of the two batteries 40 and is adjacent against to the surface of the outer rim of the two batteries 40.

When cleaning the two batteries 40, user has just to push the rod 20 moving. The spacer 30 will move according to the rod 20 in the placing slot 12. The side of the spacer 30 next to the two batteries 40 will rub against the outer rim of the two batteries 40 and rotates the two batteries 40 by its friction force. Simultaneously, the first 142 and second 142′ scrape part adjacent against to the surface of the positive 41 and negative 42 pole of the batteries 40 will clean off the dirt, by rotating the two batteries 40, on the surface of the positive 41 and negative 42 pole. Hence, achieves the effect of cleaning the two batteries 40.

Another plate sheet (no figure) can also be disposed on the other end of the two batteries 40 on the casing 10. The other plate sheet, likewise, bends to form scrape parts to clean the surface of the other positive and negative pole (no figure) of the two batteries 40.

According to the aforementioned, the present invention of battery-cleaning device is to dispose a plate sheet 14 by one end of the battery 40. The first 142 and second 142′ scrape part of the plate sheet 14 is adjacent against to the surface of the positive 41 and negative 42 pole of the batteries 40. By moving the rod 20 on the casing 10, drives the spacer 30 to rubs the outer rim of the batteries 40. Let the batteries 40 rotate and, using the first 142 and second 142′ scrape part, clean off the dirt created on the surface of the positive 41 and negative 42 pole of the battery 40. Hence, achieves the effect of cleaning the battery 40. Simultaneously, prevents rising impedance of the battery 40; so, that the battery 40 have a better characteristic to provide power continuously. Rather then running out of power after a short while of usage.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A battery-cleaning device disposed on an electronic device, the electronic device comprising a casing which has a battery slot for receiving at least one battery, the battery-cleaning device comprising:
a rod, disposed on a surface of the casing movably;
a spacer, fixed on the rod and moved with the rod, wherein the spacer is extended into the battery slot and adjacent against an outer edge of the battery; and
a plate sheet, disposed on one end of the battery and located inside the casing, the plate sheet having at least one scrape part adjacent against to a surface of one end of the battery.

2. The battery-cleaning device as claimed in claim 1, wherein the electronic device is camera, video camera or mobile phone.

3. The battery-cleaning device as claimed in claim 1, wherein the casing has a battery cover corresponding to the battery slot, and the plate sheet is fixed in an interior of the battery cover.

4. The battery-cleaning device as claimed in claim 1, wherein the casing has a concave placing slot, the spacer is placed in the placing slot, the placing slot has an opening hole communicated with the battery slot, and the spacer is passed through the opening hole and extended into the battery slot.

5. The battery-cleaning device as claimed in claim 1, wherein the spacer is made of high friction soft material.

6. The battery-cleaning device as claimed in claim 5, wherein the spacer is made of rubber.

7. The battery-cleaning device as claimed in claim 1, wherein the scrape part is formed by bending the plate sheet to the battery.

8. The battery-cleaning device as claimed in claim 1, wherein the plate sheet is made of metal.
